(19) United States
(12) Patent Application Publication
(10) Pub. No.: US 2008/0281868 A1
(43) Pub. Date: Nov. 13, 2008

(54) METHODS, APPARATUS AND PRODUCTS FOR TRANSFERRING KNOWLEDGE

(75) Inventor: Steven Elliot Gutstein, Houston, TX (US)

Correspondence Address: GILBRETH & ASSOCIATES, P.C., PO BOX 2428, BELLAIRE, TX, 77402-2428, US

(73) Assignee: CONNECTIONS CENTER, Houston, TX (US)

(21) Appl. No.: 12/037,869

(22) Filed: Feb. 26, 2008

Related U.S. Application Data
(60) Provisional application No. 60/903,815, filed on Feb. 26, 2007.

(51) Int. Cl. G06F 17/30; G06F 15/16

(52) U.S. Cl. 707/104.1; 709/201; 707/E17.044

(57) ABSTRACT

In a particular embodiment, a method is disclosed including but not limited to receiving object data at a trainer device from a consultant device; negotiating between the trainer device and the consultant device, initial assignment data to achieve the object data; sending the negotiated assignment data to a client device; receiving from the client device, performance record data recorded during performing of the assignment data; evaluating the performance record data for the object achieved in performing the assignment data; and sending amended assignment data to the client device based on the evaluation. A system and data structure are disclosed which are useful in performing the method.

### REFERENCE TO RELATED APPLICATIONS

The application claims priority of U.S. Provisional Patent Application No. 60/903,815, filed Feb. 26, 2007, which is herein incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates to methods, apparatus and products for transferring knowledge. In another aspect, the present invention relates to methods, apparatus and products for transferring knowledge from a provider, to an intermediary, and then to a receiver, and for providing feedback between the provider and intermediary, between intermediary and receiver, and feedback to the provider regarding the intermediary/receiver interaction. In even another aspect, the present invention relates to methods, apparatus and products for the treatment of autism. In still another aspect, the present invention relates to methods, apparatus, and products that may be utilized to create a digital environment useful in the treatment of autism. In yet another aspect, the present invention relates to methods, apparatus, and products to create a digital environment useful in the treatment of autism which environment may include text, audio and video content, on-line education, specialized message boards, resource libraries, chat rooms, and other tools for support, on-line progress tracking and/or collaboration.

2. Description of the Related Art

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Autism spectrum disorders (ASDs) are developmental disorders that may be characterized by impaired social interaction, problems with verbal and nonverbal communication, and unusual, repetitive, or severely limited activities and interests. While Austism is the most common, other ASDs include Asperger syndrome, Rett syndrome, childhood disintegrative disorder, and pervasive developmental disorder not otherwise specified (usually referred to as PDD-NOS). Statistically, an estimated 5 children out of every 1,000 will have autism, with males over four times more likely to have autism than females.

There are three distinctive behaviors that are generally used to characterize autism. Children with autism struggle with social interaction, have difficulties with communication, both verbal and non-verbal, and generally exhibit repetitive behaviors or narrow, obsessive interests. The range of these various behaviors may range from mild to disabling.

Certainly, impaired social interaction is the hallmark feature of autism. Many times primary care givers, that is parents, family members, or child care providers, are the first to notice symptoms of autism. Signs of autism may appear as early as infancy, manifesting as unresponsiveness to people or as an overly attentive focus on one item to the exclusion of others for long periods of time. Other times, an otherwise normally developing child may at some point withdraw and become indifferent to social engagement.

Failure to respond to their name and often avoiding eye contact with other people are other frequent signs of autism. Autistic children have difficulty interpreting what others are thinking or feeling. Such children either partially or totally tail to understand social cues, such as tone of voice or facial expressions. If fact, they many times do not even know to watch faces for clues about appropriate behavior. In short, they partially or totally lack empathy.

Self-abusive behavior such as biting or head-banging, or repetitive movements such as rocking and twirling, are common for many children with autism. Autistic children also tend to start speaking on the later side of the development curve, and when they do start speaking may refer to themselves by name instead of personal pronouns. Playing interactively with other children is difficult or non-existent for children with autism. Focusing their conversation on a narrow range of favorite topics, and sometimes in a sing-song voice, these children have little regard for the interests of the other person(s) in the conversation.

While children with autism may be abnormally sensitive to sound, touch, or other sensory stimulation, they interestingly may also have a reduced sensitivity to pain. Perhaps because of these sensitivities, many autistic children have a resistance to being cuddled or hugged.

As if the burden of autism is not enough, risk for certain co-existing conditions is higher among autistic children, including fragile X syndrome (which causes mental retardation), tuberous sclerosis (in which tumors grow on the brain), epileptic seizures, Tourette syndrome, learning disabilities, and attention deficit disorder. For example, statistically, in the range of 20 to 30 percent of children with autism develop epilepsy by adulthood.

There is no cure for autism, but rather treatment approaches, which include educational/behavioral interventions, medications, and other therapies.

In educational/behavior interventions, therapists use highly structured and intensive skill-oriented training sessions to help children develop social and language skills. Family counseling for the parents and siblings of children with autism often helps families cope with the particular challenges of living with an autistic child.

Therapies and behavioral interventions are designed to remedy specific symptoms and can bring about substantial improvement. The ideal treatment plan coordinates therapies and interventions that target the core symptoms of autism, that is, impaired social interaction, problems with verbal and nonverbal communication, and obsessive or repetitive routines and interests. Most professionals agree that the earlier the intervention, the better.

The main goals of treatment are to lessen associated deficits and family distress, and to increase quality of life and functional independence. No single treatment is best and treatment is typically tailored to the child's needs. Intensive, sustained special education programs and behavior therapy early in life can help children acquire self-care, social, and job skills. Claims that intervention by age two to three years is crucial are not substantiated. Available approaches include applied behavior analysis, developmental, and structured teaching. Educational interventions have some effectiveness in children. The limited research on the effectiveness of adult residential programs shows mixed results.

In medical approaches, doctors often prescribe an antidepressant medication to handle symptoms of anxiety, depression, or obsessive-compulsive disorder. Anti-psychotic medications are used to treat severe behavioral problems. Seizures can be treated with one or more of the anticonvulsant drugs Stimulant drugs, such as those used for children with attention deficit disorder (ADD), are sometimes used effectively to help decrease impulsivity and hyperactivity.

Medications are often used to treat problems associated with ASD. More than half of U.S. children diagnosed with ASD are prescribed psychoactive drugs or anticonvulsants, with the most common drug classes being antidepressants, stimulants, and antipsychotics. Aside from antipsychotics, there is scant reliable research about the effectiveness or safety of drug treatments for adolescents and adults with ASD. A person with ASD may respond atypically to medications, the medications can have adverse side effects, and no known medication relieves autism's core symptoms of social and communication impairments.

As for other therapies, there are a number of controversial therapies or interventions available for autistic children, but few, if any, are supported by scientific studies. Many of these other treatment approaches lack empirical support in quality-of-life contexts, and many programs focus on success measures that lack predictive validity and real-world relevance.

Along with the burden of autism, are the expensive treatment costs. A U.S. study estimated an average cost of $3.2 million in 2003 U.S. dollars for someone born in 2000, with about 10% medical care, 30% extra education and other care, and 60% lost economic productivity. Publicly supported programs are often inadequate or inappropriate for a given child, and unreimbursed out-of-pocket medical or therapy expenses are associated with likelihood of family financial problems. After childhood, key treatment issues include residential care, job training and placement, sexuality, social skills, and estate planning.

There are a number of computer implemented systems disclosed for the treatment of autism.

U.S. Publication No. 20070106479, published May 10, 2007, to Geerts et al., discloses a method and apparatus for computer modeling of the interaction between and among cortical and subcortical areas in the human brain for the purpose of predicting the effect of drugs in psychiatric and cognitive diseases, including autism.

U.S. Patent Publication No. 20070105073, published May 10, 2007, to Kullok et al, discloses a systems and methods for enhancing the holistic and temporal speech perception processes of a learning-impaired subject. A subject listens to a sound stimulus which induces the perception of verbal transformations. The subject records the verbal transformations which are then used to create further sound stimuli in the form of semantic-like phrases and an imaginary story. Exposure to the sound stimuli enhances holistic speech perception of the subject with cross-modal benefits to speech production, reading and writing. The present invention has application to a wide range of impairments including, Specific Language Impairment, language learning disabilities, dyslexia, autism, dementia and Alzheimer's.

U.S. Patent Publication No. 20070038264, published Feb. 15, 2007, to Jaax et al., discloses methods for treating autism that include applying at least one stimulus to a stimulation site within the brain of a patient with an implanted stimulator in accordance with one or more stimulation parameters. Systems for treating autism include a stimulator configured to apply at least one stimulus to a stimulation site within the brain of a patient in accordance with one or more stimulation parameters.

U.S. Patent Publication No. 20040107413, published Jun. 3, 2004 to Bixler, discloses an autism treatment system and method whereby a patient is evaluated to ascertain the patient strengths in at least five core developmental domains. The evaluations are input into a computer running a specially designed program. The program outputs a ranking of the domains according to the patient's level of functionality in each domain. Each of these levels of functionality is individually broken down into a plurality of sub-levels and the relative development or each sub-level is then graphically displayed. Suggested treatment plan topics follow the sub-levels.

### SUMMARY OF THE INVENTION

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

In a particular embodiment, a method is disclosed including but not limited to receiving object data at a trainer device from a consultant device; negotiating between the trainer device and the consultant device, initial assignment data to achieve the object data; sending the negotiated assignment data to a client device; receiving from the client device, performance record data recorded during performing of the assignment data; evaluating the performance record data for the object achieved in performing the assignment data; and sending amended assignment data to the client device based on the evaluation. A system and data structure are disclosed which are useful in performing the method.

The apparatus, products and methods of the present invention may be utilized to create a dynamic digital environment real-time knowledge community.

The apparatus, products and methods of the present invention may be utilized to provide a meaningful, information-rich, highly organized and easily accessible client-consultant communication system.

The apparatus, products and methods of the present invention may provide assignments over a network, which are therefore readily accessible, and less likely to be lost than if oral or paper assignments.

The apparatus, products and methods of the present invention may allow assignments to be provided through video communication, resulting in significantly greater understanding and compliance.

The apparatus, products and methods of the present invention may allow feedback between clients and consultants that may be highly organized and instantly accessible

The apparatus, products and methods of the present invention may provide a meaningful, highly organized, easy-to-use interface for client data entry and retrieval, including progress tracking and planning.

The apparatus, products and methods of the present invention may provide for efficient, highly organized access to client progress (including video archives).

The apparatus, products and methods of the present invention may allow for highly meaningful progress tracking.

The apparatus, products and methods of the present invention may provide highly specific and meaningful resources “pooling” and access (including videos) to facilitate the consultation process.

The apparatus, products and methods of the present invention may provide use of video clips and analysis as ongoing client training tools.

The apparatus, products and methods of the present invention may provide access to a highly organized, easily accessible, dynamically growing library of multi-media resources.

The apparatus, products and methods of the present invention may allow the use of video to greatly expedite the client-consultant learning process.

The apparatus, products and methods of the present invention may provide an effective means for consultants to work with “distance” or “remote” clients.

The apparatus, products and methods of the present invention may provide a highly effective interface for world-wide consultant-to-consultant communication and consultation.

The apparatus, products and methods of the present invention may facilitate world-wide functional client-client communications leading to the experience of a “virtual, mission-driven community.”

The apparatus, products and methods of the present invention may allow for highly meaningful treatment planning.

The apparatus, products and methods of the present invention may allow easily accessible, organized and dynamically upgradeable, customized, balanced intervention plans.

The apparatus, products and methods of the present invention may provide a highly effective, easy-to-use system for transitioning clients into the RDI process.

The apparatus, products and methods of the present invention may provide for some of the needs of clients who are on waiting lists and not yet able to access a consultant.

The apparatus, products and methods of the present invention may provide an efficient, effective RDI “entry” and socialization process.

The apparatus, products and methods of the present invention may shape client functioning as effective guides and apprentices.

The apparatus, products and methods of the present invention may automate redundant, but necessary education through on line learning.

The apparatus, products and methods of the present invention may create a dynamically evolving quality of service delivery model, by designing an effective ongoing community feedback and response process.

The apparatus, products and methods of the present invention may provide excellent consultant training, quality assurance maintenance and upgrading.

The apparatus, products and methods of the present invention may effectively provide for all members' continuing education as RDI evolves.

The apparatus, products and methods of the present invention may facilitate the consultant training process.

The apparatus, products and methods of the present invention may provide a system for meaningful, integrated treatment planning and interfacing with schools, other professionals and agencies

The apparatus, products and methods of the present invention may create a common curriculum that can integrate home and school activities.

The apparatus, products and methods of the present invention may create clear treatment definitions and distinctions from other methods and providers claiming to treat autism.

The apparatus, products and methods of the present invention may provide for an online research capability.

The apparatus, products and methods of the present invention may provide a standard for how autism services should be provided.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a diagram showing a non-limiting embodiment of information flow between a therapist IHS 12, a consultant IHS 14 and a client IHS 15.

FIG. 2 is a flowchart of another embodiment of the system which further includes but is not limited to a computer program embedded in the computer readable medium.

FIG. 3 in an illustrative embodiment of a flowchart 300 of functions is performed as shown.

FIG. 4 shows a data structure embedded in a computer readable medium.

### DETAILED DESCRIPTION OF THE INVENTION

Some embodiments of the present invention may be implemented on an Information Handling System (“IHS”). For purposes of this disclosure, an embodiment of an Information Handling System may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

The apparatus, products and methods of the present invention may be utilized to implement a Relationship Development Intervention (RDI) program useful in the treatment of autistic children. Such an RDI program may provide a private, secure digital environment for the treatment of autistic children. The digital environment may comprise wired and wireless connections and networks, local area networks, wide area networks, intranets and/or the Internet. According to the practice of the present invention, such an RDI program may include text, audio content, video content, on-line education, specialized message boards, chat rooms, resource libraries, tools for support, on-line progress tracking and/or collaboration.

In a particular embodiment, a method is disclosed including but not limited to receiving object data at a trainer device from a consultant device; negotiating between the trainer device and the consultant device, initial assignment data to achieve the object data; sending the negotiated assignment data to a client device; receiving from the client device, performance record data recorded during performing of the assignment data; evaluating the performance record data for the object achieved in performing the assignment data; and sending amended assignment data to the client device based on the evaluation. In another embodiment of the method, the object data further includes but is not limited to client object data and trainer object data. In another embodiment of the method, object data evaluating further includes but is not limited to evaluating client object data and trainer object data. In another embodiment of the method, the method further includes but is not limited to negotiating the amended assignment data between the consultant device and the trainer device based on the evaluating the client object data and trainer object data. In another embodiment of the method, the method further includes but is not limited to placing from the consultant device, a portion of the performance data in a data base associated with the object data.

In another embodiment of the method, the method further includes but is not limited to placing reference data associated with achieving the object data; in a data base wherein the reference data is selected from the group consisting of book data, lecture data, animation data and audio data. In another embodiment of the method, the performance record data further includes but is not limited to a record of the trainer and the client performing the assignment data together and wherein evaluating further includes but is not limited to evaluating trainer effectiveness in achieving the object data, the method further including but not limited to negotiating secondary assignment data to instruct the trainer in achieving the object data. In another embodiment of the method, the method further includes but is not limited to the performance record data further includes but is not limited to a record of the client performing the assignment data without the trainer and wherein evaluating further includes but is not limited to evaluating client effectiveness in achieving the object data, the method further including but not limited to negotiating secondary assignment data to instruct the client in achieving the object data. In another embodiment of the method, the method further includes but is not limited to correlating client profile data with performance evaluation data indicating the performance evaluation; placing end users into end user performance groups based on the correlating; amending the assignment data to form a plurality of amended assignment data for each performance group; and sending one of the plurality of amended group assignment data to members of each performance group. In another embodiment of the method, the method further includes but is not limited to correlating client profile data with performance evaluation data indicating the performance evaluation; placing consultants into a plurality of consultant performance groups based on the correlating; and assigning the consultant groups to end user groups based on the correlating. In another embodiment of the method, the method further includes but is not limited to initiating a digital conference data transfer between the trainer device and the consultant device. In another embodiment of the method, the assignment data further includes but is not limited to animation data demonstrating amended task data based on the evaluation of the digital record data. In another embodiment of the method, the data is transmitted between the consultant device, trainer device and client device the internet. In another embodiment of the method, the correlating is performed by machine learning.

In another particular embodiment, a system is disclosed including but not limited to a processor in data communication with a computer readable medium; and a data base embedded in the computer readable medium; a trainer interface for receiving object data at a trainer device from a consultant device; a consultant interface on the consultant device for sending and receiving negotiating data between the trainer interface and the consultant interface to negotiate between the trainer device and the consultant device, initial assignment data to achieve the object data; and a third client interface for receiving the initial assignment data at the client device and sending to the trainer interface performance record data recorded during performing of the assignment data.

In another embodiment of the system, the system further includes but is not limited to a computer program embedded in the computer readable medium, the computer program containing instructions to evaluate the performance record data for the object achieved in performing the assignment data and instructions send amended assignment data to the client interface based on the evaluation. In another embodiment of the system, the object data further includes but is not limited to client object data and trainer object data. In another embodiment of the system, the object data evaluating the performance data further includes but is not limited to evaluating client object data and trainer object data. In another embodiment of the system, the consultant interface and the client interface exchange negotiation data for negotiating the amended assignment data based on the evaluating the client object data and trainer object data.

In another embodiment of the system, the system further includes but is not limited to a data base interface for receiving from the consultant interface, a portion of the performance data for storage in the data base associated with the object data. In another embodiment of the system, the system further includes but is not limited to a fifth interface for placing reference data associated with achieving the object data, in the data base wherein the reference data is selected from the group consisting of book data, lecture data, animation data and audio data. In another embodiment of the system, the performance record data further includes but is not limited to a record of the trainer and the client performing the assignment data together and wherein evaluating further includes but is not limited to evaluating a trainer's effectiveness in achieving the object data, and wherein the first and second interfaces exchange data negotiating secondary assignment data to instruct the trainer in achieving the object data.

In another embodiment of the system, the performance record data further includes but is not limited to a record of the client performing the assignment data without the trainer and evaluating further includes but is not limited to evaluating a client's effectiveness in achieving the object data, the computer program further including but not limited to instructions to negotiate secondary assignment data to instruct the client in achieving the object data and instructions to send the secondary assignment data. In another embodiment of the system, the computer program further includes but is not limited to instructions to correlate client profile data with performance evaluation data indicating the performance evaluation, instructions to place end users into end user performance groups based on the correlating, instructions to amend the assignment data to form a plurality of amended assignment data for each performance group and instructions to send one of the plurality of amended group assignment data to members of each performance group.

In another embodiment of the system, the computer program further includes but is not limited to instructions to correlate client profile data with performance evaluation data indicating the performance evaluation and instructions to place consultants into a plurality of consultant performance groups based on the correlating and instructions to assign the consultant groups to end user groups based on the correlating. In another embodiment of the system, the trainer interface and the consultant interface exchange data initiating a digital conference data transfer between the trainer device and the consultant device. In another embodiment of the system, the system further includes but is not limited to a seventh interface for placing into the animation data demonstrating amended task data based on the evaluation of the digital record data. In another embodiment of the system, the data is transmitted between the consultant interface, trainer interface and client interface over the internet. In another embodiment of the system, the evaluation is performed by machine learning.

In another particular embodiment, a data structure is disclosed embedded in a computer readable medium, the data structure including but not limited to a first field for containing data indicating an client profile; a second field for containing data indicating performance record data of the client performing assignment data; and a third field for containing data indicating an evaluation of the a goal achieved in the performance record data. In another embodiment of the data structure, the data structure further includes but is not limited to a fourth field for containing data the assignment data; a fifth field for containing performance evaluation data indicating objects achieved in performing the task data; and a sixth field for containing data indicating amended assignment data based on the performance evaluation data. In another embodiment of the data structure, the data structure further includes but is not limited to an seventh field for containing data indicating an end user performance group for the end user based on the performance evaluation data.

In another embodiment of the data structure, the data structure further includes but is not limited to an eighth field for containing data indicating an consultant performance group for the end user based on the performance evaluation data. In another embodiment of the data structure, the data structure further includes but is not limited to a ninth field for containing data indication assignment data including animation data demonstrating amended task data based on the evaluation of the digital record data. In another embodiment of the data structure, the data structure further includes but is not limited to a tenth field for containing data indicating video data associated with the object data.

Through the apparatus, products and methods of the present invention, consultants, families, schools may have tools useful in the treatment of autism. The individuals who are participating in the RDI program will be unified by the mission to achieve a certain quality of life for themselves, their families and others, all sharing similar struggles and triumphs.

According to the practice of the present invention, the RDI program may be utilized as a curriculum for life; connecting work, home, educational and non-educational settings. The RDI program breaks the mold of communication limited by the “office visit” and provides a way for families to work with an experienced consultant regardless of geographic location. The RDI program may bring together a diverse community while tracking the results and updating the content based on the dynamic influence of the users.

The following definitions relate to a non-limiting embodiment of the present invention, particularly, the non-limiting illustrated RDI program may be based upon one or more of these definitions. These definitions are meant to relate to certain non-limiting embodiments of the RDI program, and may or may not relate to other embodiments of the present invention.

Foundations, Processes and Content as used herein means, the fundamental way that the RDI curriculum is organized. There is a distinction between a) basic physiologic foundations, b) ways of thinking, perceiving, evaluating remembering etc. that are not linked to specific tasks or settings and content areas and c) things that need to be known to be competent in specific problems and settings. Learning specific-task related information is in the area of “Contents.”

Foundations as used herein may include attachment, attention, behavior, learning and memory, perceptual and sensory-motor, and self. A Foundation is a skill that is not universally impaired in ASD but that is necessary for attaining a milestone in the stage in which it appears. Foundation deficits may represent a “static” skills required for real-world implementation of a dynamic process (e.g. decoding abilities needed for reading). They may also indicate a need for further evaluation of a potential co-occurring disorder.

Processes as used herein may include monitor and regulate, explore, study, self direct, interconnect, evaluate, and reason.

Principles as used herein relate each discovery as illustrative of a new principle. In other words, each discovery is “about” only one principle. Principles as used herein may include adequacy, balance, causality, centrality, complementarity, complexity, connectivity, development, equivalence, exclusivity, intentionally, linearity, permanence, relativity, re-occurrence, responsibility, reversibility, simultaneity, solvability, specificity, and subjectivity.

Tools as used herein are defined as sub-sets of processes. As used herein, the tools may include analyzing, appraising, attention alternating, attention shifting, attributing, broadening, challenging, clarifying, classifying, comparing, concluding, confirming, connecting (linking), consensus-forming, consolidating, decoding, deliberating, describing, disengaging, differentiating, empathizing, engaging, equivalence-forming, estimating, evaluating, troubleshooting, filtering, goal-setting, hypothesizing, hypothesis-testing, identifying, imagining, improvising, inferencing, inhibiting, integrating, interpreting, labeling, monitoring, narrating, negotiating, observing, pacing, perspective-taking, planning, predicting, previewing, prioritizing, referencing, referential thinking, refueling, reflecting, reorganizing, representing, scanning (searching), self-dialogue, spotlighting, strategizing, summarizing, synthesizing, transferring, translating, and wondering.

Discoveries as used herein means, are initial prototype of a new principle. A discovery is the child's first successful encounter with a new way of thinking, perceiving or understanding himself, others and/or his environment. Mastery of a discovery does not necessarily imply real-world competence, unless it is paired with the necessary foundations and elaborations.

Elaborations as used herein are the expansion and/or integration of one or more discoveries. Elaborations can be related to more than one tool. An elaboration is an expansion of a discovery into greater real-world functionality. Elaborations may be expansions of partners, settings, duration and frequency. They may involve decreasing adult responsibility. Elaborations may also require generalization of a principle, increased differentiation, greater conceptual awareness and greater integration with other principles and concepts.

Content Groups as used herein is a subset of content areas of which in the illustrated non-limiting embodiment there are 12: skills, skill extensions, milestones, goals, topics, objectives, lessons, assignments, feedbacks, resources, mastery, and stages.

Skills as used herein are the prototypes of specific content groups

Skill Extensions as used herein are more complex versions of skills that extend their use.

Milestones as used herein represent meaningful and measurable changes in the quality of life of the child and/or family members. They are associated with specific objectives, but not with specific tools. Milestones can be the result of the integration of mastered discoveries, elaborations, skills and skill extensions. For example, fluent, meaningful reading is the result of the working together of several reading-specific content learning along with several more general monitoring, regulating, studying, interconnecting and self directing processes. Typically, milestones are not divided into lessons but are the results of prior mastered objectives. Specific mastery resources are attached to milestones.

Goals as used herein are methods of categorizing milestones.

Topics as used herein are sub-group of goals.

Objectives as used herein are a foundation, skill, skill extension, discovery, or elaboration. Process objectives can be composed of several tools, each represented by different lessons.

Lessons as used herein are the scaffolded “part” of an objective. All objectives are broken into smaller segments called “lessons.” Lessons may include gradual scaffolding and framing changes. Different lessons of a single objective can be related to different tools. Each lesson can only be related to a single tool.

Assignments as used herein are the customized lesson for a specific client. In other words, the specific ways for a client to work on lessons.

Feedbacks as used herein are the information exchange that occurs around a specific assignment. Feedbacks are always linked to assignments.

Resources as used herein are multi-media materials that are used to enhance the learning experience and enable more reliable documentation of mastery. Resources are associated with both lessons and milestones. In practice, resources are attached to assignments and feedbacks.

Mastery as used herein means the criteria used to determine that the transfer process has been completed for the specific lesson, objective or stage.

Stages as used herein are the overall medium-range theme for the parent-consultant collaboration. In the non-limiting RDI embodiment illustrated in the present invention, there are currently 14 child stages and 6 parent stages, but certainly any suitable/desirable number of stages may be utilized. Stages attempt to link necessary content with processes in an integrated fashion. Stage names are derived from the primary discoveries made in the stage.

In the practice of the present invention, many of the above described items may contained in one or more data bases, in one or more data structures.

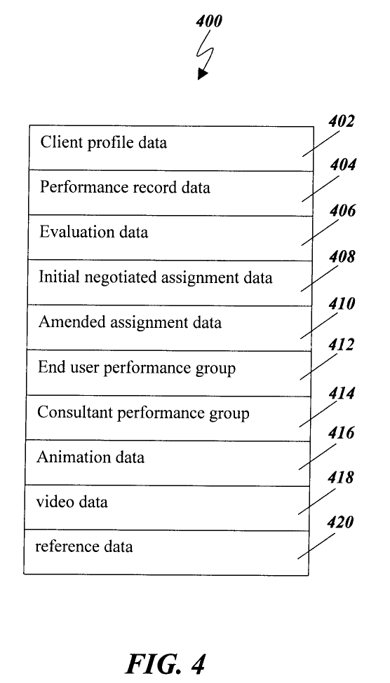

In another embodiment a data structure is disclosed embedded in a computer readable medium as shown in FIG. 4. The data structure includes but is not limited to a first field 402 containing data indicating a client profile including personal and medical information about a client patient being treated by a trainer. The client profile data also includes personal and academic information about the trainer. The data structure further includes but is not limited to a second field 404 containing data indicating performance record data of the client performing the assignment data and a third field 406 containing data indicating an evaluation of the digital record data performance evaluation data indicating objects achieved in performing the assignment. In another embodiment the data structure further includes but is not limited to a fourth field 408 containing data indicating the assignment data; and a fifth field 410 containing data indicating amended assignment data. In another embodiment the data structure further includes but is not limited to a sixth field 412 containing data indicating an end user performance group; and a seventh field 414 containing data indicating amended assignment data based on the performance evaluation data. In another embodiment the data structure further includes but is not limited an eighth field 416 containing animation data indicating instructions from a consultant to a trainer demonstrating amended task data based on the evaluation of the performance record data. In another embodiment the data structure further includes but is not limited to a ninth field 418 for containing data indicating video data including but not limited to the performance record data. In another embodiment the data structure further includes but is not limited to a tenth field 420 for containing data indicating reference data attached to object data or assignment data and accessible in the data base.

Non-limiting embodiments of the invention provide on-line education and resources. As a non-limiting example, there may be provided access to self-paced learning materials (called “eLearning”). These allow learning at an individual pace, may be reviewed as desired, and message boards may provide access to discussion with others working on the same material.

Non-limiting embodiments of the invention allow sharing of desired information with the child's world. Having an option of giving family members, friends, etc., access to the on-line resources, allows the ability to help educate the people who are invested in helping the child.

Non-limiting embodiments of the invention may provide live, on-line continuing education seminars (called “webinars”), and certainly, the video of such webinars may be available in the resource library 13.

Non-limiting embodiments of the invention may provide access to huge resource library 13 that may have powerful search capabilities, and may include newsletters, webinars, e-Learning, blogs, Powerpoint presentations, documents from parents and professionals.

Non-limiting embodiments of the invention may provide for specialized message boards, for example which may be critical in providing information and support for both parents and professionals.

Non-limiting embodiments of the invention may provide for communication between parents sharing struggling with the same issues.

Non-limiting embodiments of the invention may provide for on-line progress tracking and accountability. As a non-limiting example, all digital communication with the child's consultant may be automatically organized in one place, accessible from anywhere with an internet connection. The illustrated RDI system may automatically compile all the communication between a client and consultant, including a list of every objective mastered, or in progress.

Non-limiting embodiments of the invention may provide an on-line journal (called a “web-log” or “blog”) to assist the client in staying on track. This allows a client to keep a complete, running record of successes, challenges, and insights through a daily journal entry. This blog may be private or open to allowed subscribers.

Non-limiting embodiments of the invention may provide numerous administrative tools. As a non-limiting example, the RDI system may allow a client to upload video clips sent to the consultant to a secure site. As another, the RDI system may provide personal calendars and reminders, and access to RDI system related files, whether video or text, chats or blogs, favorite newsletters, etc., all organized in one place.

Non-limiting embodiments of the invention allow a for sharing of a child's progress with others in the form of a multimedia portfolio, which may include video clips and consultant notes. Access may be allowed to other children's records at the next stage (thanks to parents who explicitly sign consent to allow this) to help give others a preview of what comes next.

Certainly, the present invention may need to allow for compliance with any governmental rules, regulations, codes, statutes, and/or laws relating to privacy and security of communications between health care providers and patients, for example the Health Insurance Portability and Accountability Act of 1996 (HIPAA, Title II) as it pertains to electronic health care transactions and security and privacy of health data. Thus, non-limiting embodiments of the invention allow for a certain level of security, especially as necessary to comply with the HIPAA regulations.

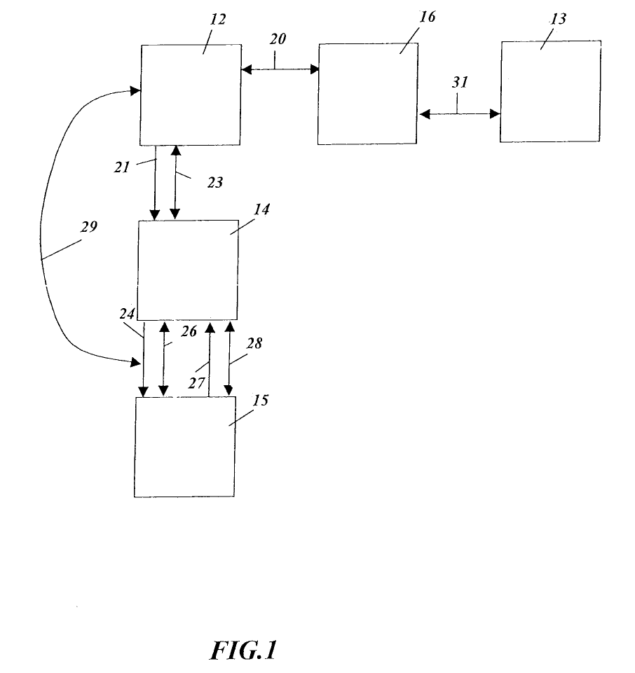

Referring now to FIG. 1, there is shown a non-limiting embodiment of information flow between a therapist IHS 12 a consultant IHS 14 and a client IHS 15. In many of the non-limiting examples of the illustrated RDI system, the client is either the child or the parent.

Regarding a particular consultant/client, the therapist may access (20) objective database 16 and retrieve an objective, which may be an objective for the consultant and/or for the client. This objective database may be linked (31) to one or more resources databases 13 to assist in carrying out or implementing the objective.

In the non-limiting embodiment of RDI as illustrated, there are a number of types of objectives as follows. Foundations may be described as physiologic functions (sensory, motor, perceptual, basic memory etc.) mostly in first few stages. Content and Procedural Knowledge may be described as the terms used in education for static skills. Discoveries may be described as the initial prototype of a new cognitive process or principle. Elaborations may be composed of more than one tool, or could be an extension of a tool's use. Milestones may be described as the integration of content and process in the real world.

The sole purpose of lessons is to break the larger objective into smaller “sub-objectives.” Each lesson should briefly describe a small short-term goal that is manageable for that specific client. It is very important to understand that lessons are not instructions, and are not intended to tell anyone what to do. Rather, they are merely a sub-set of the particular objective.

To facilitate progress, consultants may want to make sure that the lesson becomes “portable” to clients. In other words, have the client translate the lesson in a brief meaningful phrase that they can carry around with them and be mindful about, during the course of their day.

A non-limiting examples of some sample objective nos. 1641, 529, and 74 follows:

| | |
|---|---|
| Objective ID | 1641 |
| Stage | Stage 6: 4-5 |
| Type | Elaboration |
| Process | Experience Sharing |
| Tool | Co-Regulation |
| Lesson | Breakdown & Repairs 5: When you do things together you |
| | will inevitably lose coordination with your partners and |
| | have to fix it |
| Description | Perceives breakdowns in action -coordinating during |
| | collaborations. The child monitors and repairs coordination |
| | breakdowns when involved in more complex activities with |
| | more complex partners. Actions clearly communicate that |
| | coordinating actions with partners was the highlight of |
| | shared activities |
| Mastery | Partners: Father, mother, familiar consultant/therapist, other |
| | familiar caregivers, Settings: Garage (home), sidewalk (near |
| | home), walking route (familiar), classroom (home), back |
| | yard (or enclosed yard space), kitchen, bathroom, personal |
| | bedroom |

| | |
|---|---|
| Objective ID | 529 |
| Stage | Stage 10:10-12 |
| Type | Foundation |
| Process | Dynamic Analysis |
| Tool | Commonalities & Differences Analysis |
| Lesson | Solutions: Different ways measuring can produce the |
| | same results |
| Description | Effectively using the concept of equivalence applied to |
| | measurement Expects that different forms of measurements |
| | can be used in an equivalent manner, to describe the |
| | quantitative attributes of a stimulus. Uses direct comparison |
| | and nonstandard units to describe the measurements of |
| | objects (e.g. Measure your desk by using the length of a |
| | ballpoint pen. How many ballpoints pens would be roughly |
| | equal to the length of your desk? The width of your desk? |
| | Which is longer? ). Tells time to the nearest half hour |
| | and relates time to events (e.g., before/after, shorter/longer). |
| Mastery | Partners: familiar larger peer group, unfamiliar small peer |
| | group, large peer groups, large mixed groups, teams, |
| | groups, or clubs. Setting: Park, classroom (organized), |
| | neighborhood peer gathering, shopping center (small), store |
| | (familiar), unfamiliar home, restaurant, airplane, familiar |
| | playground (non -chaotic), transportation (other), camping |
| | trip (family), vacation home |

| | |
|---|---|
| Objective ID | 74 |
| Stage | Stage 10:10-12 |
| Type | Milestone |
| Process | Mental Operations |
| Tool | Multiple & Simultaneous Processing |
| Lesson | Milestone |
| Description | Expects that performance can be evaluated differently by |
| | oneself and an outside observer, with neither being correct |
| | or incorrect |
| Mastery | Partners: familiar large peer group, unfamiliar small peer |
| | group, large peer group, large mixed groups, teams, groups, |
| | or clubs. Setting: Classroom (organized), neighborhood |
| | peer gathering, shopping center (small), store (familiar), |
| | unfamiliar home, restaurant, airplane, familiar playground |
| | (non -chaotic), transportation (other), camping trip |
| | (family), vacation home |

From a review of the tables above, it is evident that there are a number of components for each objective. There may be an objective summary and description. The may be objective mastery criteria. There may be the lesson description, that is, the progressive way to reach the objective through breaking it into steps, gradually transferring responsibility and gradually decreasing the framing. RDI provides for collaborative creation of the lessons and permanent storage thereof. There may be an assignment description, that is, of what the client is asked to do for any specific lesson. These type of assignment descriptions may be collected from consultants an provided in a resource library. There may be feedback communication about the assignment, which may be contributed to the resource library 13.

The various objectives may have prerequisites, and the RDI system may be configured to not allow selection of an objective for a client unless the prerequisite objectives have been sufficiently mastered. Other objectives may have co-requisites, and similarly, the RDI system may be configured to require co-selection of such co-requisites. Certainly, suitable overrides by a user with the necessary authority may be provided.

Upon selecting and obtaining a particular objective, the therapist will communicate (21) that objective to the consultant. This communication 21 may comprise information in any form, non-limiting examples of which include text, voice, video, graphics, pictures, and/or music.

Various resources 13 are indexed by lessons, and may be accessed by the therapist, consultant and/or client with appropriate authority. Consultants can attach a number of different types of resources to feedbacks to enhance and clarify them and provide the client with a different type of challenge or discovery. As non-limiting examples, resources can range from a video clip from the resources library, an e-learning module, or an archived parent webinare, piece of music, art or poetry. Resources can be “borrowed” from resource library 13 or from outside sources. Consultants can tailor resources to the clients' specific learning style and preferences (e.g. more visual or auditory). Parents will also attach resources to their feedbacks. When consultants ask parents to send them a video, they are actually asking them to attach the video as a resource.

In the illustrated RDI system, the consultant's role may include reframing ASD as a chronic disorder requiring remediation, framing the primary goal as quality of life, fostering readiness for and commitment to a new parental role, helping parents to become good apprentices, framing RDI as a day-long process of mindful parenting, transferring competence from yourself to clients and from clients to child, and using the RDI tools to create powerful memories: previews and reflections of different experiences to aid in the child's development.

Again, it should be understood, that the objective is not just an instruction or command to the consultant, but rather begins a negotiated dialog (23) between the therapist and consultant on how to carry out the objective with the client.

Once the negotiated dialog 23 is concluded, the consultant will need to create an assignment 24 for the client. To begin working with a client, consultants may create an assignment relevant to the objective, and may even divide the objective into sub-objectives to create an assignment. These lessons may provide the consultant and the client with a goal on which to focus. The assignment provides the client with an expectation of what the consultant expects them to do.

In the present invention, assignments provide the consultant's specific recommendations about how to begin working on the specific lesson. It is convenient to think of them as “homework” assignments. The assignment, typically sent by the consultant provides the first specific step for the client to take in mastering the lesson. The point of this communication (24) is to guide the client on their journey of mental discovery

Once this assignment is communicated (24) with the client, there begins a negotiated dialog (26) between consultant and client on how to carry out the assignment. This communication 24 may comprise information in any form, non-limiting examples of which include text, voice, video, graphics, pictures, and/or music. Once the negotiated dialog 26 is concluded the client will then have an assignment to carry out.

In the process of working on the assignment, the client may provide a report (27) regarding progress/completion of the assignment to the consultant. The report parameters, i.e., timing, format, content, frequency, medium, etc., are negotiated (26) between the consultant and client. This report may be in any form, non-limiting examples of which include text, voice, video, pictures, and the like. As a non-limiting example, the client may provide a report 27 in the form of a web cam video of a physical exercise.

Feedback dialog 28 then is utilized to provide feedback from the consultant regarding the report 27, and any communications back from the client.

According to non-limiting embodiments of the present invention, consultants and their clients employ an online communication documentation system, involving careful documentation of the consultation process and clear feedback provided to clients. Ideally, this system is located on highly secure servers and only available to parents and consultants who are authorized to access the system. Both clients and consultants may have immediate access to detailed and summary information of their communication and work product. Some embodiments of the present invention include an online progress tracking and documentation system, in which both client and consultant document progress through clear, empirical data.

The feedback consultants provide may comprise short, succinct and precise recommendations, so that clients have greater success applying methods to their daily lives. Feedbacks are geared towards influencing the client's analysis, observation, reflection and problem-solving abilities. In some non-limiting embodiments of the present invention, consultants and parents may have the ability to use webcams and camcorders to provide video feedback on a short term basis, thus dramatically increasing the effectiveness of consultation communication.

Feedback dialog 29 may provided feedback to the therapist regarding any aspect of the consultant/client interaction, and may allow the therapist to provide communication regarding same.

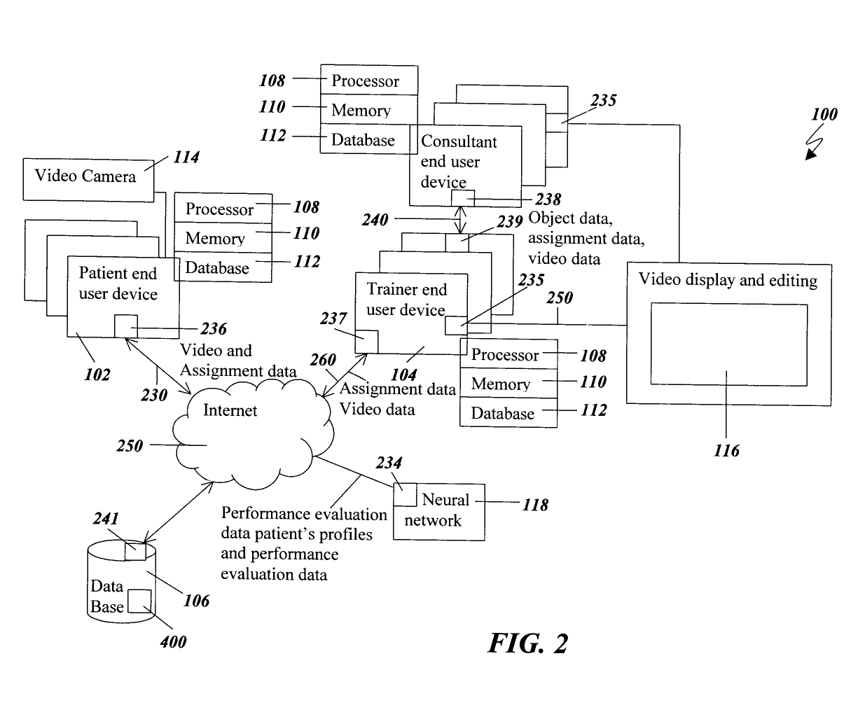

Turning now to FIG. 2, in an illustrative embodiment a system is disclosed of an patient end user device including a processor 108 in data communication with a computer readable medium 106, 110, 112 and a data base 106, 112 embedded in the computer readable medium; a trainer interface 239 for receiving object data at a trainer device from a consultant device; a consultant interface 238 on the consultant device for sending and receiving negotiating data between the trainer interface and the consultant interface to negotiate between the trainer device and the consultant device, initial assignment data to achieve the object data; and a third client interface 236 for receiving the negotiated initial assignment data at the client device and sending to the trainer interface performance record data recorded during performing of the assignment data. A video display and editing terminal 116 is provided for viewing, editing and annotating the video data in the system including but not limited to performance record data.

Referring now to FIG. 2, there is shown another embodiment of the system which further includes but is not limited to a computer program embedded in the computer readable medium 400, the computer program containing instructions to evaluate the performance record data for the object achieved in performing the assignment data and instructions send amended assignment data to the client interface based on the evaluation. The client device 102 sends video data from video camera 114 to the trainer device in the form of the performance record data discussed below. In another embodiment of the system the object data further include but are not limited to client object data and trainer object data and the evaluating the performance data further includes but is not limited to evaluating client object data and trainer object data. In another embodiment, the system further negotiates the negotiated assignment data between the trainer device and the client device. The consultant interface and the client interface exchange negotiation data for negotiating the amended assignment data based on the evaluating the client object data and trainer object data. A data base interface 241 for receiving from the consultant interface, a portion of the performance data for storage in the data base associated with the object data. In another embodiment the system further includes but is not limited to a fifth interface 241 for placing reference data associated with achieving the object data, in the data base wherein the reference data is selected from the group consisting of book data, lecture data, animation data and audio data.

In another embodiment of the system, the performance record data further includes but is not limited to a record of the trainer and the client performing the assignment data together and wherein evaluating further includes but is not limited to evaluating a trainer's effectiveness in achieving the object data, and wherein the first and second interfaces exchange data negotiating secondary assignment data to instruct the trainer in achieving the object data. In another embodiment of the system, the performance record data further includes but is not limited to a record of the client performing the assignment data without the trainer and wherein evaluating further includes but is not limited to evaluating a client's effectiveness in achieving the object data, the computer program further including but not limited to instructions to negotiate secondary assignment data to instruct the client in achieving the object data and instructions to send the secondary assignment data. In another embodiment, the trainer interface and the consultant interface exchange data initiating a digital conference data transfer between the trainer device and the consultant device. In another embodiment of the system, the system further includes but is not limited to a seventh interface for placing animation data demonstrating amended task data based on the evaluation of the digital record data into the assignment data. In another embodiment of the system the data is transmitted between the consultant interface, trainer interface and client interface over the internet 250. In another embodiment, the evaluation is performed by machine learning at neural network 118 via interface 234.

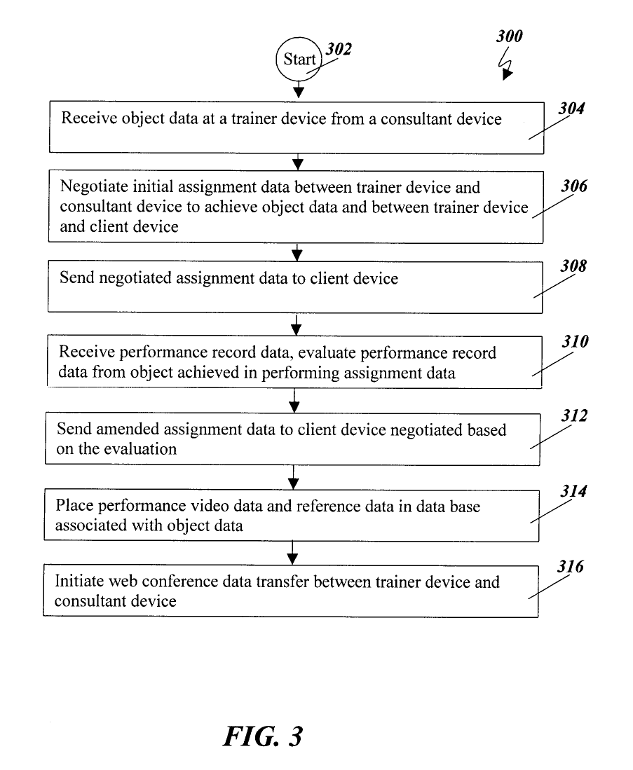

Moving now to FIG. 3, in an illustrative embodiment a flowchart 300 of functions is performed as shown in FIG. 3. The order of execution of functions performed in additional embodiments not dictated by any flow chart in this disclosure, as in other embodiments any function can be executed in any order in relation to other functions or left out of execution altogether. An illustrative embodiment starts at terminal 301 and proceeds to block 302. At block 302 an illustrative embodiment receives object data at a trainer device from a consultant device. In an illustrative embodiment, the method then proceeds to block 304 where an illustrative embodiment negotiates initial assignment data between the trainer device and the consultant device to achieve the object data. In an illustrative embodiment, the method then proceeds to block 306 where an illustrative embodiment sends negotiated assignment data to the client device. The negotiated assignment data is further negotiated a second time, this time the negotiation is between the trainer device and the client device. In an illustrative embodiment, the method then proceeds to block 308 and receives performance record data, evaluates the performance record data for objects achieved in performing the assignment data. In an illustrative embodiment, the method then proceeds to block 310 and sends amended and negotiated assignment data to the client device amended based on the evaluation data and the negotiations. In an illustrative embodiment, the method then proceeds to block 312 and places performance video data and reference data in the database associated with the object data and assignment data. In an illustrative embodiment, the method then proceeds to block 314 and initiates a web conference data transfer between a trainer device and a consultant device. In an illustrative embodiment, the method then places end users and consultants in performance groups, sends amended assignment data to end user performance groups. Obviously, flow through the system and/or system logic may be repeated through any part or all of the system resources and/or logic.

Non-limiting embodiments of the present invention may provide for managing the feedback process. In the present invention feedback may be defined as the communication that occurs between clients and the consultant (or consultant/therapist) concerning and in reference to a specific lesson. Feedbacks are organized around lessons, and may be in any desired medium, non-limiting examples of which include text, graphics, audio, pictures, and/or video.

Non-limiting embodiments of the present invention may provide for teaching clients to provide meaningful feedback. There is value in keeping feedback simple. Feedbacks should be written so that the client recognizes the need to carefully analyze, observe, monitor, deliberate and plan. As with the initial lessons/objectives, feedbacks should not be directives for actions in and of themselves. The feedback author should be very clear about how the recipient should respond to the feedback.

In the practice of non-limiting embodiments of the present invention, feedbacks are part of a dynamic communication process initiated around the assignment. Of course not all parts of feedback will be recorded online. It is helpful to use the written feedbacks to spotlight and clarify what has occurred in live meetings and phone calls, and to document what is expected in the future. Certainly, feedbacks do not have to be written, as in various non-limiting embodiments, they can be audiotaped or videotaped with a webcam or with a camcorder. Feedbacks may even be in graphics format (like a diagram or flow chart).

Various non-limiting embodiments allow numerous choices for the communication method for feedbacks. For example, the consultant may manage a live consultation session using a web cam as part of a live session. The present invention does contemplate liberal use of video cameras and webcams, for delivering feedback, for client feedback, and for demonstrations.

It should be understood that the therapist may provide the consultant with assignments for the consultant to carry out. The information interaction between the therapist and consultant regarding such an assignment will be similar to that between the consultant and client discussed above. In some instances, an assignment for the client may also contain a corresponding assignment for the consultant to carry out and report back to the therapist.

For any assignment, there is a point at which “mastery” is achieved. The resource database 13 contains information relating to mastery for each objective. As a non-limiting example, resource database 13 may contain a video clip detailing mastery of a certain physical movement.

Stage mastery is evaluated through mastered milestones for the given stage. In the non-limiting RDI embodiment illustrated, there may be 14 child stages and 6 parent stages as follows:

Child Stages:
Stage 01: Laying Foundations: Basic Attachment and emotional engagement along with Perceptual, Sensory, Motor, Memory and Attention foundations;
Stage 02: Appropriating Apprenticeship: Co-regulation, maintaining engagement, identification, productive uncertainty & pattern-recognition;
Stage 03: Coordinating Collaborations: Communicative & co-regulatory responsibility, co-variation & broadband communication;
Stage 04: Appreciating Alternatives: Perceptions, perspectives, intentions, outcomes, representations, interpretations & solutions;
Stage 05: Constructing Minds: Anticipation, self-dialogue, visualization, imagination, deliberation, observation & evaluation;
Stage 06: Forming Relationships: Friendship, interpersonal responsibility, comparisons, attributions and expectations;
Stage 07: Discovering Selves: Self-awareness, -monitoring, -evaluating, and -challenging, coordinating minds, translating, self-referencing, re-fueling & soothing;
Stage 08: Analyzing Appraisals: Critical analysis, hypotheses, performance, value, importance and contextual appraisals;
Stage 09: Creating Connections: Temporal (past, present & future), conceptual, personal, inferential, creative, emotional & interpersonal;
Stage 10: Managing Multiples: Levels, roles, relationships, settings, demands, goals, solutions and meanings;
Stage 11: Transforming Knowledge: Previewing, spotlighting, extending, summarizing, synthesizing integrating and consolidating;
Stage 12: Mastering Problems: Strategic thinking, grey-area problem-solving, troubleshooting, task analysis and contextual understanding;
Stage 13: Paving Pathways: Goals, dreams, reflections, trends, progressions, systems, complex patterns, relationships and transformations; and,
Stage 14: Embarking on Journeys: Intimacy, Identity, challenges, possibilities & the search for deeper meaning & understanding.

Parent Stages:
Stage 01: Education;
Stage 02: Readiness & Commitment;
Stage 03: Planning;
Stage 04: Apprenticeship;
Stage 05: Guiding; and,
Stage 06: Internalization & Transfer.

As discussed, stage mastery is evaluated through mastered milestones for the given stage. Thus, milestones should represent meaningful and measurable changes in the quality of life of the child an/or family members. They may be associated with specific objectives, but usually not with specific tools. Milestones can be the result of the integration of mastered discoveries, elaborations, skills and skill extensions. For example, fluent, meaningful reading is the result of the working together of several reading-specific content learning along with several more general monitoring, regulating, studying, interconnecting and self directing processes. Typically, milestones are not divided into lessons but are the results of prior mastered objectives. Specific mastery resources may be attached to milestones.

Non-limiting examples of a child's milestones include the following:
Accepts guide's communication to stop or limit his actions;
Shifts attention from higher to less reinforcing tasks, when required to do so;
Pro-actively seeks out guides to reference the appropriateness of his actions and success of his performance;
Maintains his work area in an organized manner;
Regularly observes guides without prompts, to determine appropriate actions;
Thinking about things from other people's perspectives;
Motivated to troubleshoot performance on problems to pinpoint why his performance turned out the way it did;
Accurately trouble-shoots performance on problems and can pinpoint why performance turned out the way it did;
Sustains effort in the face of low immediate payoff, to get closer to desired goal;
Desires to work on areas of weakness to improve them;
Desire for new challenges;
Searches for new areas of interest;
Constructs fully elaborated project plans including time, resources and actions. Scheduling is based on realistic deadlines, other commitments and resource availability;
Uses the public library, internet, reference books, journals and other resources, for research purposes;
Wanting to make your friends like you;
Saving up for something wanted;
Effectively communicates the problem he is having in a manner that allows effective guidance to be provided;
Strives to develops new areas of competence;
Makes generally accurate evaluations of his task performance; and,
Takes verbal (oral or written) quantitative problems and translates them into a sequence of mathematical procedures.

In operation of the non-limiting RDI program of the present invention, the consultant is able to train the parent in the process of guided participation. Through the present invention, the consultant is not a therapist but rather a consultant to the family. In the non-limiting embodiment as described, RDI is an educational and training program for parents and others who are primarily involved with the child's development. It is not a therapy for the child.

Similarly then, there are milestones for the parent. Non-limiting examples of a parent's milestones include the following:
Parent perceives the child as more motivated to function as parent's apprentice, accepting parental guidance to become more masterful;
Parent is able to set limits for the child and feel reasonably confident that the child will respect them;
Parent perceives that the child values parent's time together over other activities and objects;
Parent perceives a decreased need to prompt and cue the child, because the child is showing greater self-regulation;
The child appears much more interested in how parent feel;
Parenting feels like it is becoming a more natural, intuitive process;
Parent observes a significant reduction in conflicts and stresses related to the child;
Family functioning seems more like normal on a day-to-day basis;
Parent feels more hopeful and less fearful about what the future holds for the child;
Parent notices that the child is acting in a more considerate manner towards family members;
Parent feels a decreased need to act as a buffer and advocate for the child;
Parent feels emotionally healthier, less anxious and more hopeful;
Parent observes a significant increase in communication for experience-sharing (multiple channels);
Parent perceives that the child's disorder is no longer the major stress factor in parent's daily life;
Parent perceives the child as engaging significantly more in planned, thoughtful action;
Parent notices a significant increase in the child's ability to generate productive creative ideas and responses;
Parent has an increased belief in the future independence of the child;
Parent has decreased concerns about how other children will perceive the child;
Parent perceives the child as interested in what Parent think and in wanting to know about parent's daily life; and,
Parent perceives the child's significantly increased desire to understand more about him or herself.

In the non-limiting embodiment as described, the RDI curriculum is comprised of a carefully developed, systematic set of developmental objectives that is a critical part of the RDI process. It is in continual development. Specific objectives will be revised and improved upon as feedback is received from various participants in the RDI process. As part of the non-limiting embodiment, the resource library 13 may be provided with communications from therapists, clients, and consultants regarding any objective and the like. Thus, there is not only a feedback process between therapist/consultant and consultant/client, but also a feedback process wherein a participant may “publish” feedback to the entire community. Non-limiting embodiments of the present invention provide for a “filtering” or “gatekeeper” process for such publication. As a non-limiting example, the RDI system may be designed to allow only a therapist to publish any information to the entire community. Certainly, there may be a feedback process in which consultants and clients may “propose” or “suggest” publication to certain gatekeeper therapists.

Because of the various feedback mechanisms, and the growing nature of the various databases (i.e., objectives, and the like) the RDI system as an intervention program is in continual development, of not only new material, but also of changing/editing/eliminating old material. Methods and principles will likely evolve over the period in which they are involved with RDI.

Some of the evolution may occur as a result of having the RDI system either automatically, or user directed, analyze the data for any possible improvements to treatment. This dynamic evolution may be used to weed out certain objectives (or consultants), or make additions, edits, changes, deletions to part or all of certain objectives (or any other part of the RDI system). As a non-limiting embodiment, the RDI system may review mastery data of clients and determine the common parameters of those having high mastery or low mastery, to determine what should or should not be done.

In the non-limiting embodiment as described, there is no special setting, equipment or activity that defines RDI. It is important to note that RDI is not a “play based” approach, nor is it a social development or social skills program.

To achieve any desirable results, RDI requires an extensive commitment of time and energy by parents. Such parents are expected to engage in regular journaling and reflection through the RDI system, as guided by the consultant.

Parents are expected to construct through the RDI system, Mission Previews, under the consultant's guidance. They are expected to regularly review and update these previews. An essential part of RDI is based on benefiting from participating in the larger community of parents and consultants

In the non-limiting embodiment as described, the illustrated RDI system may provide a consultant with supervision, certification, recertification, ongoing training, peer supervision, webinars, resources sharing, a network of amazing expertise, and/or forums.

In the practice of the non-limiting embodiment of the present invention, consultants may spend the bulk of their RDI time facilitating the development of parents as effective guides. This will “leverage” the knowledge of the consultants. Likewise, the therapist will so leverage knowledge through the consultants.

In the non-limiting embodiment as described, consultants may provide clear guidance and may act in a conservative, careful manner, when determining mastery of any objective. If unsure of mastery, consultants have avenues for receiving guidance from the therapist through communications 23.

Through the non-limiting illustrated RDI embodiment, consultants may construct careful scaffolding plans based on the specific needs of each client (parent) focused on providing competent challenges for the purpose of gradually transferring competence and responsibility to the client.

Consultants write clear, systematic assignments to break up each objective into manageable parts, customized to the needs of the child and parents. Assignments are clearly documented in the client's online chart and are the precursor to their initiation of communication feedback with clients.

Consultants make sure that parents have the appropriate understanding of what and how they are expected to work with their child, during periods between consultant visits. This information is clearly documented and available to clients in their online chart.

Through the RDI system, consultants may use webcams and similar methods to ensure that clients have a clear reference point available to them at any time to recall specific recommendations and assignments they have been given.

Through the RDI system, consultants may effectively help clients translate assignments into portable phrases that they can use throughout their day to search for developmental opportunities

The illustrated RDI system will allow consultants to clearly indicate and document all client decisions that serve as significant obstacles to the family's ability to benefit from RDI. Parents must clearly indicate their awareness that they recognize the impact of such decisions.

In order to effectively use RDI, consultants clearly communicate that parents are required to analyze and critique their own work in a specific manner, prior to submitting feedback such as video segments to the consultant.

Consultants teach parents how to provide constructive feedback, and provide guidance for parents so that they can successfully conduct ongoing self-analyses, including analysis of short videotape segments. Under the consultant's guidance, parents learn how to conduct a dynamic communication process, to review progress and plan future objectives

Consultants actively encourage and facilitate each client's involvement in the RDI community including participation in webinars, e-learning, forums and other means of interfacing with the RDI community.

Consultants regularly evaluate whether they are making sufficient progress with each client using tools available through RDI.

While the present invention has been illustrated by reference to a three level communication between therapist, consultant and client, it should be understood that higher levels of communication are contemplated. An obvious non-limiting example would be a four level communication between the therapist/consultant/parent/client, in which the therapist provides the consultant with a lesson for working with the child. The consultant would then instruct the parent and then monitor how the parent and child interact on the lesson.

While the present invention has been illustrated with the client receiving information from one consultant, it is contemplated that the client may communicate with one consultant, either with different consultants on different objectives, or with two or more consultants on a single objective. Likewise the consultant may communicate with more than one therapist on a single client.

While the present invention has been illustrated with communication occurring between adjacent levels, it is contemplated that communication may take place between non-adjacent levels.

It should be understood that a therapist may communicate with a number of consultants, and that a consultant may communicate with a number of clients.

The apparatus, products and methods of the present invention are described mainly by reference to the treatment of autism. However, it should be understood that the present invention has utility in a wide variety of other environments for the transfer of knowledge from the provider of knowledge to an intermediary and then to a receiver. In many cases the provider of the knowledge has more skill regarding the knowledge than the intermediary and the receiver, and the intermediary has more skill regarding the knowledge then the receiver. Non-limiting examples of environments include sports, medicine, music, physical therapy, schools, management, training, sales, martial arts, various trades, military tactical training, various professions, and the like. Non-limiting examples of various provider/intermediary/receiver relationships include provider/intermediary/receiver, therapist/consultant/client, coach/assistant coach/player, doctor/nurse/patient, doctor/intern/patient, doctor/physical therapist/patient, manager/junior manager/trainee, master/teacher/student, senior partner/junior partner/associate, senior manager/junior manager/staff, department head/professors/students, and the like, which may all be generically represented as consultant/trainer/client.

In non-limiting embodiments, part or all of the methods described herein may be described as instructions for an information handling system, and stored on media or transmitted by a propagated signal. In non-limiting embodiments, part or all of the data structures described herein may be stored on media or transmitted in a propagated signal.

In another non-limiting embodiment, an IHS may include computer readable media as described above including instructions embodying part or all of the methods described herein.

As utilized herein, “computer readable” and “computer implemented” should be understood to include “IHS readable” and “IHS implemented.”

The present invention may be implemented in various environments, including combinations of different environments. For example, in embodiments, the present invention may be implemented in one or more information handling systems, by one or more humans/individuals, and in any combination thereof. In embodiments, portions of the present invention may be implemented in hardware, software, firmware, and any combination thereof. The invention is also directed to information handling system products comprising software stored on any IHS useable medium. Such software, when executed in one or more IHS, causes the IHS(s) to operate as described herein. Embodiments of the invention employ any IHS useable or readable medium, known now or in the future. Examples of computer useable mediums include, but are not limited to, primary storage devices (for example, any type of random access memories), secondary storage devices (for example, hard drives, floppy disks, compact discs (CDs), ZIP disks, tapes, magnetic storage devices, optical storage devices, micro-electromechanical systems (MEMS), nanotechnological storage devices, etc.), and communication mediums (wired and wireless connections and networks, local area networks, wide area networks, intranets, Internet, etc.). Further embodiments, including equivalents, variations, and modifications (including additional or fewer components), will be apparent to persons skilled in the relevant art(s) from the teachings herein.

The apparatus and methods of the present invention have described and illustrated by examples. While these apparatus and methods have been described in terms of particular embodiments and illustrative figures, one of ordinary skill in the art will recognize that the invention and the appended claims are not limited to the embodiments or figures described. In addition, where methods and steps described above indicate certain events occurring in certain order, those of skill in the art will recognize that the ordering of certain steps may be modified and that such modifications are in accordance with the invention, and embodiments of the invention. Additionally certain of the steps maybe performed concurrently or in parallel processes when possible, as well as performed sequentially, as described above. Thus, to the extent that there are embodiments of the invention, which are within the spirit of the disclosure or equivalent to the inventions found in the claims, it is intended that the patent will cover those embodiments as well. Finally, all publications, patents and patent applications cited in this specification are herein incorporated by reference in their entirety as if each individual reference was specifically and individually set forth herein.

What is claimed is:

1. A method comprising:
receiving object data at a trainer device from a consultant device;
negotiating between the trainer device and the consultant device, initial assignment data to achieve the object data;
sending the negotiated initial assignment data to a client device;
receiving from the client device, performance record data recorded during performing of the assignment data;
evaluating the performance record data for the object achieved in performing the assignment data; and
sending amended assignment data to the client device based on the evaluation.

2. The method of claim 1, wherein the object data further comprises client object data and trainer object data and wherein object data evaluating further comprises evaluating client object data and trainer object data.

3. The method of claim 2, further comprising:
negotiating the amended assignment data between the consultant device and the trainer device based on the evaluating the client object data and trainer object data.

4. The method of claim 1, further comprising:
negotiating the negotiated assignment data between the client device and the trainer device based on the object data.

5. The method of claim 1, further comprising:
placing from the consultant device, a portion of the performance data in a data base associated with the object data.

6. The method of claim 5, further comprising:
placing reference data associated with achieving the object data, in a data base wherein the reference data is selected from the group consisting of book data, lecture data, animation data and audio data.

7. The method of claim 1, wherein the performance record data further comprises a record of the trainer and the client performing the assignment data together and wherein evaluating further comprises evaluating trainer effectiveness in achieving the object data, the method further comprising:
negotiating secondary assignment data to instruct the trainer in achieving the object data.

8. The method of claim 1, wherein the performance record data further comprises a record of the client performing the assignment data without the trainer and wherein evaluating further comprises evaluating client effectiveness in achieving the object data, the method further comprising:
negotiating secondary assignment data to instruct the client in achieving the object data.

9. The method of claim 1, the method further comprising:
correlating client profile data with performance evaluation data indicating the performance evaluation;
placing end users into end user performance groups based on the correlating;
amending the assignment data to form a plurality of amended assignment data for each performance group; and
sending one of the plurality of amended group assignment data to members of each performance group.

10. The method of claim 1, the method further comprising:
correlating client profile data with performance evaluation data indicating the performance evaluation;
placing consultants into a plurality of consultant performance groups based on the correlating; and
assigning the consultant groups to end user groups based on the correlating.

11. The method of claim 1, the method further comprising:
initiating a digital conference data transfer between the trainer device and the consultant device.

12. The method of claim 1, wherein the assignment data further comprises animation data demonstrating amended task data based on the evaluation of the digital record data.

13. The method of claim 1, wherein the data is transmitted between the consultant device, trainer device and client device the internet.

14. The method of claim 10, wherein the correlating is performed by machine learning.

15. A system comprising:
a processor in data communication with a computer readable medium; and
a data base embedded in the computer readable medium;
a trainer interface for receiving object data at a trainer device from a consultant device;
a consultant interface on the consultant device for sending and receiving negotiating data between the trainer interface and the consultant interface to negotiate between the trainer device and the consultant device, initial assignment data to achieve the object data; and
a third client interface for receiving the negotiated initial assignment data at the client device and sending to the trainer interface performance record data recorded during performing of the assignment data.

16. The system of claim 15, further comprising:
a computer program embedded in the computer readable medium, the computer program containing instructions to evaluate the performance record data for the object achieved in performing the assignment data and instructions send amended assignment data to the client interface based on the evaluation.

17. The system of claim 15, wherein the object data further comprises client object data and trainer object data and the evaluating the performance data further comprises evaluating client object data and trainer object data.

18. The method of claim 15, further comprising:
negotiating the negotiated assignment data between the trainer device and the client device.

19. The system of claim 18, wherein the consultant interface and the client interface exchange negotiation data for negotiating the amended assignment data based on the evaluating the client object data and trainer object data.

20. The system of claim 15, further comprising:
a data base interface for receiving from the consultant interface, a portion of the performance data for storage in the data base associated with the object data.

21. The system of claim 15, further comprising:
a fifth interface for placing reference data associated with achieving the object data, in the data base wherein the reference data is selected from the group consisting of book data, lecture data, animation data and audio data.

22. The system of claim 15, wherein the performance record data further comprises a record of the trainer and the client performing the assignment data together and wherein evaluating further comprises evaluating a trainer's effectiveness in achieving the object data, and wherein the first and second interfaces exchange data negotiating secondary assignment data to instruct the trainer in achieving the object data.

23. The system of claim 16, wherein the performance record data further comprises a record of the client performing the assignment data without the trainer and wherein evaluating further comprises evaluating a client's effectiveness in achieving the object data, the computer program further comprising instructions to negotiate secondary assignment data to instruct the client in achieving the object data and instructions to send the secondary assignment data.

24. The system of claim 16, the computer program further comprising instructions to instructions to correlate client profile data with performance evaluation data indicating the performance evaluation, instructions to place end users into end user performance groups based on the correlating, instructions to amend the assignment data to form a plurality of amended assignment data for each performance group and instructions to send one of the plurality of amended group assignment data to members of each performance group.

25. The system of claim 16, the computer program further comprising:
instructions to correlate client profile data with performance evaluation data indicating the performance evaluation and instructions to place consultants into a plurality of consultant performance groups based on the correlating and instructions to assign the consultant groups to end user groups based on the correlating.

26. The system of claim 15, wherein the trainer interface and the consultant interface exchange data initiating a digital conference data transfer between the trainer device and the consultant device.

27. The system of claim 15, further comprising:
a seventh interface for placing into the animation data demonstrating amended task data based on the evaluation of the digital record data.

28. The system of claim 15, wherein the data is transmitted between the consultant interface, trainer interface and client interface over the internet.

29. The system of claim 15 wherein the evaluation is performed by machine learning.

30. A data structure embedded in a computer readable medium, the data structure comprising:
a first field for containing data indicating an client profile;
a second field for containing data indicating performance record data of the client performing assignment data; and
a third field for containing data indicating an evaluation of the a goal achieved in the performance record data.

31. The data structure of claim 30, further comprising:
a fourth field for containing data the assignment data;
a fifth field for containing performance evaluation data indicating objects achieved in performing the task data; and
a sixth field for containing data indicating amended assignment data based on the performance evaluation data.

32. The data structure of claim 31, further comprising:
an seventh field for containing data indicating an end user performance group for the end user based on the performance evaluation data.

33. The data structure of claim 32, further comprising:
an eighth field for containing data indicating an consultant performance group for the end user based on the performance evaluation data.

34. The data structure of claim 33, further comprising:
a ninth field for containing data indication assignment data including animation data demonstrating amended task data based on the evaluation of the digital record data.

35. The data structure of claim 34, further comprising:
a tenth field for containing data indicating video data associated with the object data.
